(19) United States
(12) Patent Application Publication
(10) Pub. No.: US 2013/0328943 A1
(43) Pub. Date: Dec. 12, 2013

(54) DIFFUSER INCLUDING PARTICLES AND BINDER

(71) Applicants: Ion Bita, San Jose, CA (US); Evgeni Yuriy Poliakov, San Mateo, CA (US); Sapna Patel, Fremont, CA (US)

(72) Inventors: Ion Bita, San Jose, CA (US); Evgeni Yuriy Poliakov, San Mateo, CA (US); Sapna Patel, Fremont, CA (US)

(73) Assignee: QUALCOMM MEMS Technologies, Inc., San Diego, CA (US)

(21) Appl. No.: 13/494,898

(22) Filed: Jun. 12, 2012

(51) Int. Cl. G09G 5/10; B05D 5/06; G02B 5/02

(52) U.S. Cl. 345/690; 359/599; 427/162

(57) ABSTRACT

Systems, methods, and apparatuses for improving brightness, contrast, and/or viewable angle of a reflective display. A display includes a diffuser including particles and a binder over a substrate. At least some of the particles protrude from a planar or substantially planar upper surface of the binder, which provides a topographical pattern for the diffuser. The display includes a planarization layer on the diffuser. The planarization layer provides a planar or substantially planar surface for the formation of display elements over the planarization layer.

### TECHNICAL FIELD

This disclosure relates to diffusers for electromechanical display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Interferometric modulator devices may be configured as reflective displays which display a particular image based on positions of the plates of the interferometric modulator. Various interferometric reflective displays are sensitive to the direction of incoming light and viewer position. In particular, the color reflected from the interferometric modulators can change depending on the viewing angle of the viewer. This phenomenon can be referred to as a “color shift.” Designs that reduce such “color shift” can provide more desirable color output at different viewing angles.

### SUMMARY

The systems, methods and devices of the disclosure each have several innovative aspects, no single one of which is solely responsible for the desirable attributes disclosed herein.

With regard to at least one innovative aspect of the subject matter described in this disclosure, in order to improve the displayed image as a function of the viewing angle of a display such as an interferometric modulator display, a light diffusive element (or “diffuser”) may be incorporated to the display. A diffuser can, for example, scatter light over a larger range of angles thereby decreasing the sensitivity of color to direction of incoming light.

One innovative aspect of the subject matter described in this disclosure can be implemented in a light diffuser. The light diffuser includes a substrate, a diffusion layer over the substrate, the diffusion layer including particles and a binder, at least some of the particles protruding from a planar upper surface of the binder, and a planarization layer on the diffusion layer, wherein the planarization layer has a refractive index greater than 1.

Another innovative aspect of the subject matter described in this disclosure can be implemented in a method of manufacturing a diffuser usable with a display including a plurality of display elements. The method includes depositing a mixture including particles and a binder over a substrate, wherein, after depositing the mixture, at least some of the particles protrude from a planar upper surface of the binder in a diffusion layer, and forming a planarization layer having a refractive index greater than 1 on the diffusion layer.

Another innovative aspect of the subject matter described in this disclosure can be implemented in a light diffuser. The diffuser includes a substrate, means for scattering light, the scattering means over the substrate and including particles and a binder, at least some of the particles protruding from a planar upper surface of the binder, and a planarization layer on the diffusion layer. The planarization layer has a refractive index greater than 1.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 illustrates an example of a light diffuser including a diffusion layer.

FIG. 10 is a cross-sectional view of a display configured to display different colors and including a diffusion layer.

FIG. 11A illustrates an example of an isotropic diffusion layer according to some implementations.

FIG. 11B illustrates a top view of the isotropic diffusion layer shown in FIG. 11A.

FIG. 12A illustrates an example of an anisotropic diffusion layer according to some implementations.

FIG. 12B illustrates a top view of the anisotropic diffusion layer shown in FIG. 12A.

FIG. 13 is a flow diagram illustrating an example manufacturing process for a display including a diffusion layer.

FIG. 14 is a cross-sectional view of a display configured to display different colors and including a diffusion layer having different topographical patterns in different areas of the display.

FIGS. 15A-15C illustrate cross sections of light diffusers during fabrication of a diffusion layer having different topographical patterns in different areas.

FIGS. 16A and 16B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Reflective displays generally rely on ambient light and/or artificial light incident on each reflective display element. The color and contrast of an image displayed by some reflective displays such as interferometric modulator displays can be sensitive to the viewing angle of a user and/or an incident angle of light that is incident on the display. Aspects of this description provide implementations that may reduce the effect of a change in viewing angle on a displayed image such as on the color of the images. According to some implementations, a light diffuser includes a diffusion layer including particles and a binder. The particles protrude from an upper surface of the binder to provide a topographical pattern for the diffusion layer. A planarization layer is formed on the diffusion layer.

In some implementations, incident light may be scattered over a larger range of angles for second order blue display elements in comparison to first order red and first order green display elements. The light reflected from these interferometric modulators (IMODs) will be scattered a second time upon passing again through the diffusion layer. The light diffuser provides mixing to reduce the color shift and can provide increased mixing for display elements (such as 2^{nd} order blue IMODs) that are more susceptible to color shift. In some implementations, the diffusion layer can be configured such that light that is incident on active areas of a display element may be scattered, while light that is incident on inactive areas (for example, black mask structures) is not scattered.

Some implementations of the subject matter described in this disclosure may realize one or more of the following potential advantages. At least three components (such as the particles, the binder, and the planarization layer) of a light diffuser can be varied, thereby improving performance and integration of the diffusion layer with a display. For example, the refractive index and structure of the particles, the refractive index and thickness of the binder, the refractive index and thickness of the planarization layer, and a ratio of the binder to the particles can be varied. Further, by scattering light differently according to different areas of a display corresponding to different color display elements, an image displayed by the reflective display may have reduced color shift. By scattering incident light and light that is reflected by the display in areas corresponding to active regions of the display and not the inactive areas (for example where black masks are located), the display may exhibit improved contrast.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

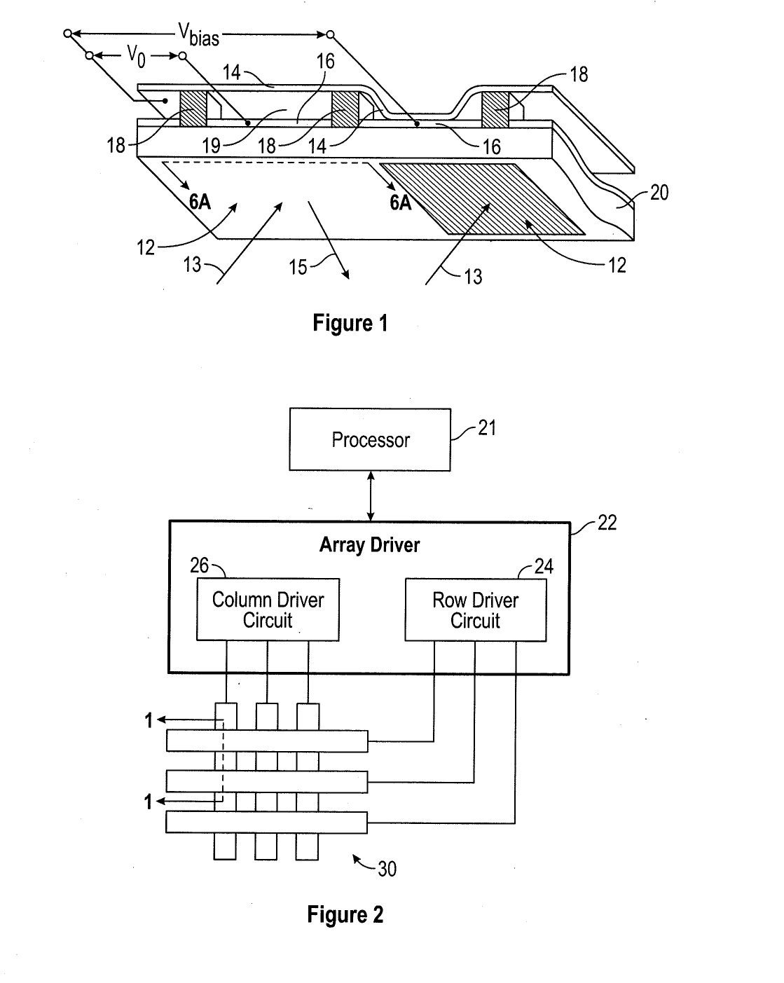

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

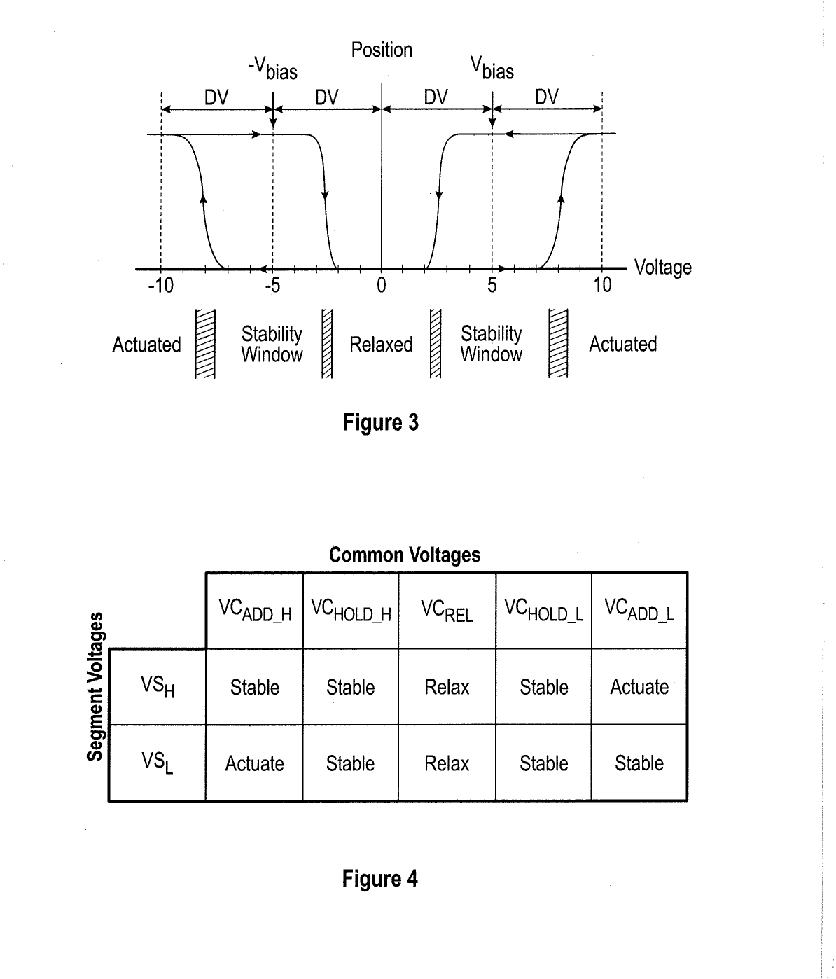

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

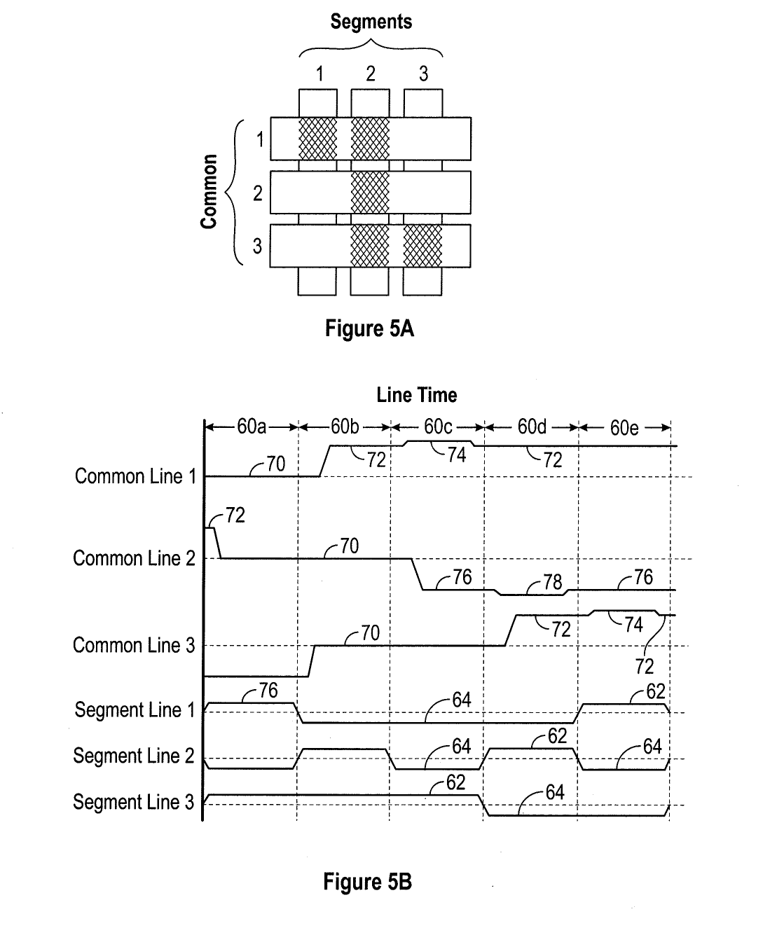

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

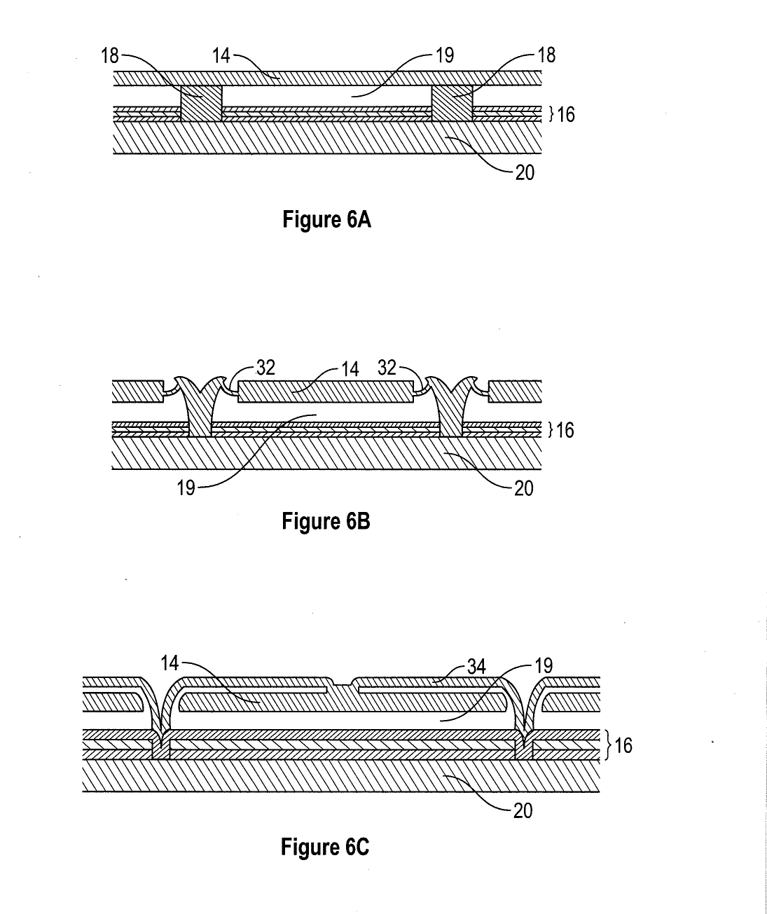

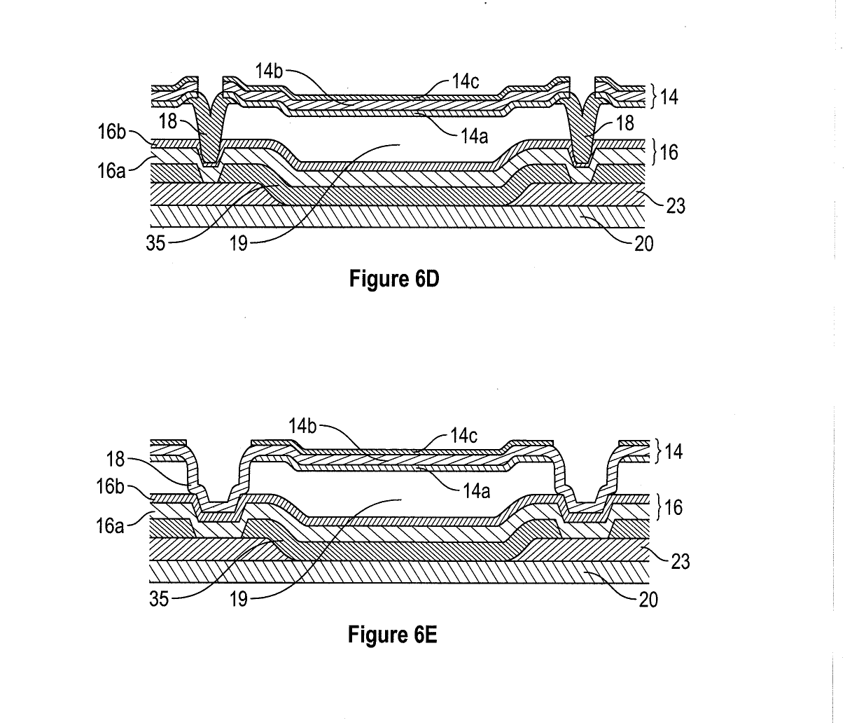

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

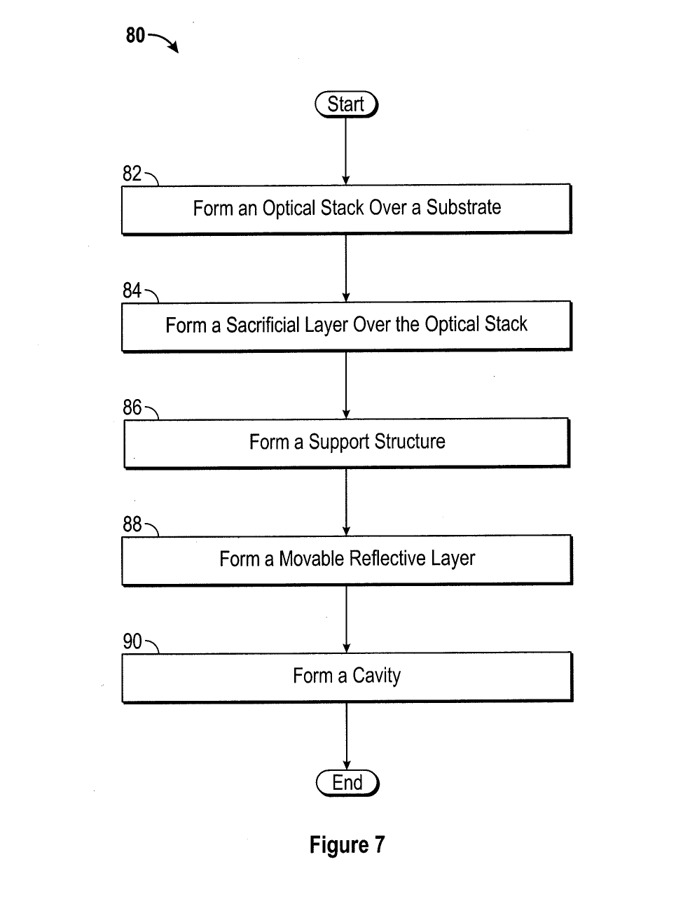

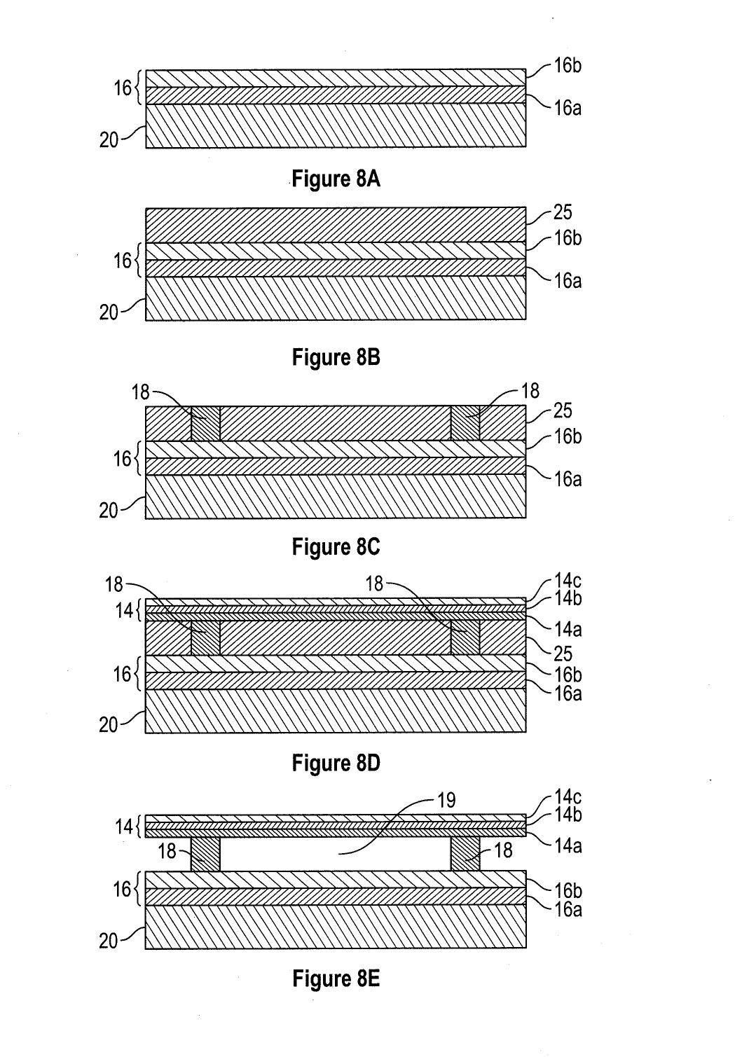

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As discussed above, a reflective display element, such as an IMOD, may include a pair of conductive surfaces, one or both of which may be reflective, wholly or in part, and capable of relative motion upon application of an appropriate electrical signal. The position of one surface in relation to another alters the thickness of an optical resonance cavity between the pair of conductive surfaces and can change the optical interference of light incident on the display element.

IMODs are generally specular in nature and they are sensitive to the direction of incoming light and viewer position. The color of light reflected from an IMOD may vary for different angles of incidence and reflection. For example, with reference again to FIG. 1, for an IMOD 12 in a relaxed position, as incident light 13 travels along a particular path to the movable reflective layer 14 of the IMOD 12, the light is reflected from the IMOD 12, as indicated by the ray 15, and travels to a viewer. The viewer perceives a first color when the light 15 reaches the viewer as a result of optical interference between the movable reflective layer 14 and the optical stack 16 in the IMOD 12. Optical interference in the IMOD 12 depends on optical path length of light propagated within the IMOD 12 (such as through a gap 19). When the viewer moves or changes his/her location, thereby changing the viewing angle, however, the light 15 received by the viewer travels along a different path with different optical path lengths within the IMOD 12. Different optical path lengths for the different optical paths yield different outputs from the IMOD 12. The user therefore perceives different colors depending on his or her angle of view.

The amount of color shift may also be affected by the size of the gap 19. As discussed above, the wavelength of reflected light can be adjusted by changing the height of the gap 19, for example, by changing the position of the movable reflective layer 14 relative to the optical stack 16 for different IMODs 12. In some implementations, a display may include a plurality of display elements configured to reflect light having different wavelengths, thereby generating a color image. Each of the different display elements may be configured as IMODs having a different structure, for example, different gap spacing, where the height of the gap 19 for each of the IMODs is different and thus corresponds to the different colors.

In order to improve the viewing angle of an IMOD display, a light diffusive element (or “diffuser”) may be incorporated in the display. The diffuser can have a textured surface or a variation in composition to scatter light that is incident on the diffuser. The diffuser, for example, may include one or more layers of a material such as glass or a suitable transparent or translucent polymer resin, for example, polyester, polycarbonate, polyvinyl chloride (PVC), polyvinylidene chloride, polystyrene, polyacrylates, polyethylene terephthalate, polyurethane, and copolymers or blends thereof. Other materials may also be used. The diffuser can, for example, scatter light reflected from the IMOD element over a larger range of angles, providing mixing and thereby decreasing sensitivity to the direction or angle of incoming or incident light.

According to some implementations, a topographical pattern diffuser may be provided in the form of a composite topographical layer. For example, the composite topographic layer may include a mixture of a binding material and particles. The binding material and particles may be apportioned according to a predetermined ratio. The ratio may be such that the binding material does not cover the entire surface of the particles in the composite topographical layer.

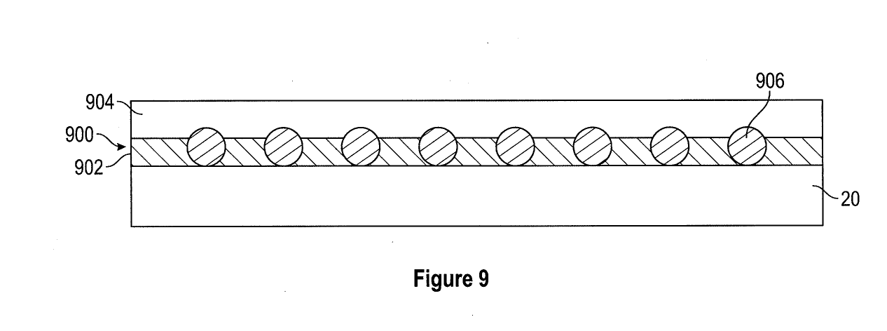

FIG. 9 illustrates an example of a light diffuser including a diffusion layer 900. The diffusion layer 900 is in the form of a composite topographical layer. As shown in FIG. 9, the optical structure includes a substrate 20, a diffusion layer 900 over the substrate 20, and a planarization layer 904 on the diffusion layer 900. The diffusion layer 900 includes particles 906 and a binder 902. At least some of the particles 906 protrude from a planar or substantially planar upper surface of the binder 902. Although not illustrated in FIG. 9, in one implementation not all of the particles 906 protrude above the surface of the binder 902. The planarization layer 904 has a refractive index greater than about 1.

The substrate 20 may include glass, plastic, or the like having a thickness in the range of about 25 μm to about 700 μm, for example 500 μm. The substrate 20 may have a refractive index in the range of about 1.2 to about 1.8, for example about 1.5. While not illustrated, other optical coupling layers may be provided between the substrate 20 and the diffusion layer 900 and/or on an opposite side of the substrate 20 as the diffusion layer 900.

In some implementations, an optical coupling layer (not shown) may be disposed between the substrate 20 and the diffusion layer 900. For example, an optical coupling layer may be configured as a light guiding layer, a polarizer, a thin-film index-matching layer, or another diffusion layer. The optical coupling layer may provide an improved optical response for the IMOD display, and can enable the production of a thinner display device architecture for multi-layered film and/or structured optical stacks that are positioned close to an IMOD image plane.

The diffusion layer 900 includes a binder 902 and particles 906. The binder 902 may include a material such as glass, resin, elastomer, or the like. For example, the binder 902 may include a spin on glass (SOG) material, an epoxy, a light curable transparent resin, a thermo-processed transparent resin which forms a glass layer in a hardened state, or the like. The binder 902 may have a refractive index in the range of about 1.2 to about 2, for example about 1.5.

The binder 902 may have a thickness of about 0.2 μm to about 5 μm, for example about 0.5 μm. In some implementations, the binder 902 may be formed of a material, such as inorganic SOG that is generally compatible with the fabrication of display elements (such as IMODs) above the surface of the diffusion layer 900. As a result, maintaining a thickness of binder 902 in the range of, for example, 0.2 μm to about 1 μm may provide improved performance for display elements that are fabricated above the diffusion layer 900.

The particles 906 may include a solid material, such as silica, plastic, resin, or the like. The particles 906 may have a refractive index in the range of about 1.2 to about 2, for example about 1.5. The particles 906 may be spherical or substantially spherical in shape as shown in FIG. 9, or may have an aspherical shape as will be discussed in greater detail with reference to FIG. 12A-12B below. For example, aspherical particles 906 may have an aspect ratio in the range of about 1 to about 3, for example about 1.5. The particles 906 having a spherical shape may have a radius in the range of about 0.5 μm to about 10 μm, for example, about 1 μm. As shown in FIG. 9, portions of the particles 906 protrude above or, in different orientations, extend past, the planar or substantially planar upper surface of the binder 902. The extending portions, or hemispheres, form a topographic pattern or scatter features, as illustrated in FIG. 9.

The planarization layer 904 is formed on the diffusion layer 900. In contrast to the term “over,” which provides spatial orientation of components, the term “on” also indicates proximity to or even contact between components. For example, the planarization layer 904 may directly contact the binder 902 and the particles 906, filling in gaps between the particles 906. The planarization layer 904 provides a planar (for example, substantially planar) or level surface (for example, suitable for forming a display element such as an IMOD over the planarization layer 904), and does not merely make the upper surface relatively more planar than whatever the planarization layer is formed on. The planarization layer 904 may include a SOG material, an epoxy, a light curable transparent resin, a thermo-processed transparent resin, or the like. The planarization layer 904 has a refractive index greater than 1. Air would not be considered a planarization layer 904. The planarization layer 904 may have a refractive index of about 1.01 to about 1.85, and in some implementations from about 1.2 to about 1.8. For example, the planarization layer 904 may have a refractive index of about 1.65. The refractive index of the planarization layer 904 may be set to reduce the effect of back scattering (for example, reflection of incident light) by the diffusion layer 900 such that the diffusion layer 900 is configured to provide substantially forward scattering of incident light. For example, the refractive indices of the planarization layer 904 and the diffusion layer 900 (for example, the binder 902 and/or the particles 906 of the diffusion layer 900) may be selected so that incident light and/or reflected light at certain angles (for example, proximate to the normal) is refracted rather than reflected upon interaction with the interface between the diffusion layer 900 and the planarization layer 904.

As shown in FIG. 9, the planarization layer 904 is formed on (for example, directly on) a surface of the diffusion layer 900 including the binder 902 and the particles 906. The planarization layer 904 may have a thickness that is based upon the size of the scatter features of the diffusion layer 900. For example, the combined thicknesses of the binder 902 and the planarization layer 904 may be greater than the size of the particles 906. In some implementations, the planarization layer 904 may have a thickness of about 1 μm to about 150 μm to provide a planar or substantially planar surface between the diffusion layer 900 and the display elements formed thereover.

The refractive index of any of the components of the optical structure, such as the substrate 20, the binder 902, the particles 906, and the planarization layer 904 may be varied based according to different implementations. For example, the binder 902 may have the same refractive index as that of the substrate 20, or may have a different refractive index than that of the substrate 20. The particles 906 may have the same refractive index as that of the substrate 20, or may have a different refractive index than that of the substrate 20. In some implementations, the binder 902 may have the same refractive index as the refractive index of the particles 906. In other implementations, the binder 902 may have a different refractive index than that of the particles 906. A difference between the refractive index of the binder 902, the particles 906, and the substrate 20 may be set within a range of about 0.01 to about 0.5, for example about 0.1. For example, in some implementations, the binder 902 may have a refractive index of about 1.38, the particles 906 may have a refractive index of about 1.47, and the substrate may have a refractive index of about 1.52. In some implementations, the binder 902 and the particles 906 may have a refractive index of about 1.47, while the substrate has a refractive index of about 1.52. Other variations are also possible as discussed above.

The difference in refractive index between the binder 902, the particles 906, and the substrate 20 may be based on the display device implementation. For example, the refractive index of the binder 902 and the particles 906 can be lower than the refractive index of the substrate 20 for display devices that include an artificial front light. In some implementations, for display devices that do not utilize an artificial front light, the refractive index of one or more of the binder 902 and the particles 906 may be equal or substantially equal to the refractive index of the substrate 20.

The planarization layer 904 may have a refractive index that is the same as or different from the refractive index of one or more of the binder 902 and the particles 906. In some implementations, the planarization layer 904 may have a first refractive index, while the binder 902 and the particles 906 may have a second refractive index that is different than the first refractive index. A difference between the first and second refractive indices may be in the range of about 0.05 to about 0.6. For example, the refractive index of the binder 902 may be the same as the refractive index of the particles 906 (for example, about 1.47). In this implementation, the refractive index of the particles 906 and the binder 902 is different than the refractive index of the planarization layer 904 (for example, about 1.38). In this example, the diffusion layer 900 and the planarization layer 904 exhibit a hemispherical lens type diffusion characteristic.

In some implementations, the planarization layer 904 may have a first refractive index, the binder 902 may have a second refractive index that is different than the first refractive index, and the particles 906 may have a third refractive index that is different than the first and second refractive indices. A difference between the first, second, and third refractive indices may be in the range of about 0.05 to about 0.6. For example, the planarization layer 904 may have a refractive index of about 1.38, the binder 902 may have a refractive index of about 1.52, and the particles 906 may have a refractive index of about 1.47. In this example, the diffusion layer 900 and the planarization layer 904 exhibit a spherical lens type diffusion characteristic.

The planarization layer 904 may be configured to provide a converging effect on light that is scattered by the light diffuser. Unlike transmissive display technologies (such as LCD), the viewing angle of a reflective display is based in part on the scattering of light on a return path from the reflective display elements. The brightness and contrast of a reflective display is based in part on light that is incident on active areas of the display. The planarization layer 904 is configured to improve brightness of the display by converging light that is scattered by the diffusion layer 900 and is incident on the reflective display elements. The reflected light is scattered on a return path by the diffusion layer 900, thereby improving the viewing angle of the reflective display. Transmissive displays (such as LCD) may include diffusers that are configured to divergently scatter transmitted light in order to improve the viewing angle. However, a planarization layer, such as the planarization layer 904, is generally not provided with diffusers that are included in transmissive displays because such a planarization layer would narrow the viewing angle of the transmitted light.

By controlling an amount and distribution of the material of the binder 902 and the particles 906, the topographical pattern of the diffusion layer 900 may be controlled. As discussed herein, the refractive index of each of the particles 906, the binder 902, and the planarization layer 904 may have a different value than each other and that of the substrate 20. As a result, a number of parameters for controlling the light scattering properties of the diffusion layer 900 may be configured as desired. These parameters include the refractive index of the binder 902, the refractive index of the particles 906, and the ratio of the binder 902 to the particles 906. A diffusion layer 900 may have different patterns by varying one or more of a particle type, particle size, particle density, particle distribution, binder type, and a level of the planar upper surface of the binder relative to the particles.

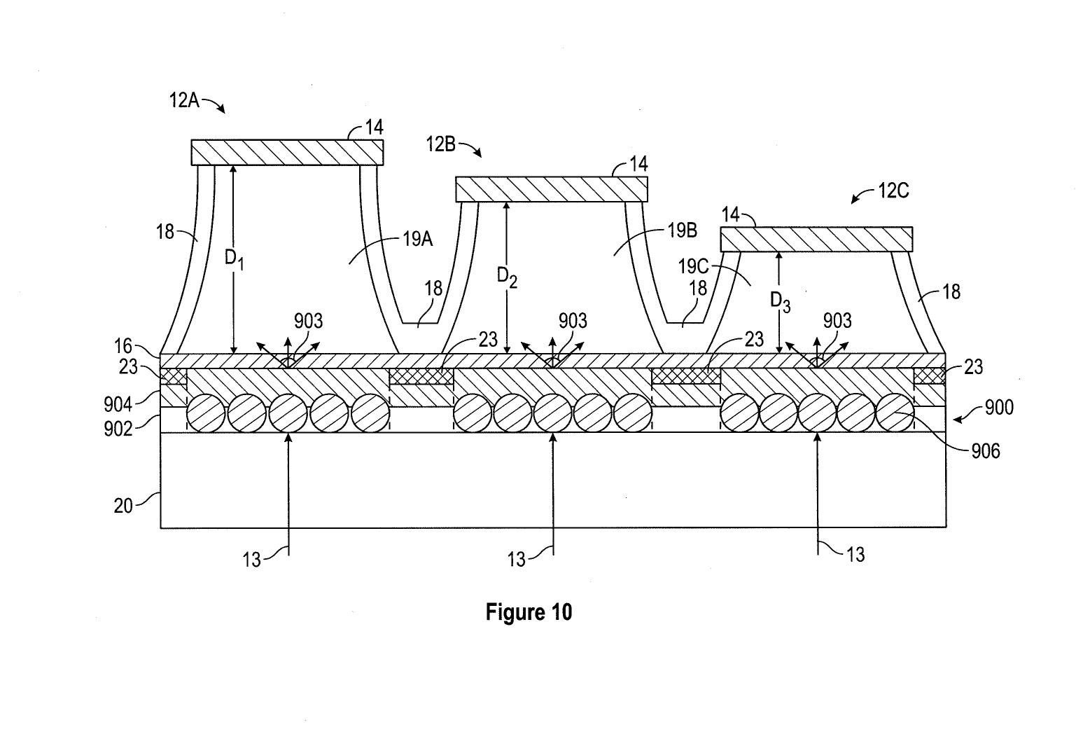

FIG. 10 is a cross-sectional view of a display configured to display different colors and including a diffusion layer 900. The diffusion layer 900 has a topographical pattern. As illustrated, each of the IMODs 12A, 12B, and 12C includes a reflective layer 14 that is supported by support posts 18 that extend from a surface of the planarization layer 904. Other IMODs, for example described herein with respect to FIGS. 6A-6E, or other display elements are also possible.

The IMODs 12A, 12B, and 12C may be configured to have different gap heights when in the state illustrated in FIG. 10, where a gap height in this implementation corresponds to a distance from the optical stack 16 to the reflective layer 14. For example, a first IMOD 12A may have a gap 19A having a first gap height D₁, a second IMOD 12B may have a gap 19B having a second gap height D₂, and a third IMOD 12C may have a gap 19C having a second gap height D₃ such that D₁>D₂>D₃.

As discussed above, the gap heights D₁, D₂, and D₃ correspond to the color of light that is reflected by the respective IMODs 12A, 12B, and 12C in the state illustrated in FIG. 10. For example, each of the gap heights D₁, D₂, and D₃ may correspond to a distance that is equal or substantially equal to the same factor (for example, one half) of the wavelength of the corresponding color to be reflected by the respective IMODs 12A, 12B, and 12C. For example, the IMOD 12A may correspond to a red display element having a gap height D₁ within the range of about 310 nm to about 375 nm, for example about 325 nm. The IMOD 12B may correspond to a green display element having a gap height D₂ within the range of about 250 nm to about 285 nm, for example about 255 nm. The IMOD 12A may correspond to a blue display element having a gap height D₃ within the range of about 225 nm to about 240 nm, for example about 237 nm. In this configuration, the IMODs 12A, 12B, and 12C may be described as being configured to reflect a first order color of light.

In some implementations, the IMODs 12A, 12B, and 12C may have gap heights which correspond to different factors of the wavelength of the corresponding color to be reflected by the respective IMODs 12A, 12b, and 12C. For example, the IMOD 12A may be configured as a blue display element having a gap height D₁ equal to about one wavelength of blue light, the IMOD 12B may be configured as a red display element having a gap height D₂ equal to about one-half of a wavelength of red light, and the IMOD 12C may be configured as a green display element having a gap height D₃ equal to about one-half of a wavelength of green light. In such a configuration, the IMOD 12A may be described as a display element configured to reflect a second order color of light, while the IMODs 12B and 12C may be described as display elements configured to reflect a first order or reference order color of light. For example, the IMOD 12A may correspond to a blue display element having a gap height D₁ within the range of about 450 nm to about 480 nm, for example about 475 nm. The IMOD 12B may correspond to a red display element having a gap height D₁ within the range of about 310 nm to about 375 nm, for example about 325 nm, and the IMOD 12C may correspond to a green display element having a gap height D₂ within the range of about 250 nm to about 285 nm, for example about 255 nm.

As shown in FIG. 10, the planarization layer 904 includes a plurality of black mask structures 23. As discussed above, the black mask structures 23 can include a plurality of layers, and may be configured to include, for example, a conductive contact or drive line for applying a voltage to the optical stack 16. The black mask structures 23 may be configured to inhibit light from being reflected from or transmitted through inactive portions of the display, thereby increasing the contrast ratio of the display. Display elements, such as IMODs 12A, 12B, and 12C, are formed over the planarization layer 904. The planarization layer 904 provides a planar or substantially planar surface appropriate to act as a base for the IMODs 12A, 12B, and 12C.

In some implementations, as shown in FIG. 10, the particles 906 are provided in regions that do not correspond to the black mask structures 23. For example, the substrate 20 may be etched to provide shallow trenches (not shown) in regions corresponding to active areas, such as areas that are not above a black mask structure 23, of the IMODS 12A, 12B, and 12C. During deposition of the particles 906 and the binder 902, the particles 906 may congregate to the regions corresponding to the shallow trenches of the substrate 20. The diffusion layer 900 may be configured such that a surface with reduced light intensity distribution properties, such as a planar or substantially planar surface that is free or substantially free of particles 906, is provided in the areas corresponding to the black mask structures 23. As a result, scattering of light from the diffusion layer 900 does not occur in these areas and the function of the black mask structures 23 is improved.

Light 13 that is incident on the diffusion layer 900 through the substrate 20 is scattered to a plurality of light output angles as shown, for example, within a scattering range 903. The scattering range 903 (or angular distribution of light exiting the planarization layer 904) may be a function of one or more parameters (such as refractive indices, particle size, particle shape, layer thicknesses, binder 902 to particle 906 ratio, combinations thereof, and the like) of the diffusion layer 900, the planarization layer 904, and the substrate 20, as discussed herein. Light that is reflected by the display elements, such as the IMODs 12A, 12B, and 12C is scattered on a return path. The diffusion layer 900 provides mixing (e.g., constructive interference) of light reflected by each of the IMODs 12A, 12B, and 12C. Due to the mixing of the light reflected by each of the IMODs 12A, 12B, and 12C, light that is reflected by the display exhibits additional light intensity peaks at different viewing angles. As a result, the diffusion layer 900 is configured to reduce the effect of color shift which may be caused by the display element gap heights D₁, D₂, and D₃.

In some implementations, a first diffusion layer 900 may be configured to scatter a beam isotropically and a second diffusion layer 900 may be configured to scatter the beam anisotropically. In some implementations, an isotropic diffusion layer 900 may be used to provide an increase for an in-plane (e.g., display surface plane) viewing angle relative to out-of-plane viewing angle. In some implementations, an anisotropic diffusion layer 900 may be used to tailor the viewing cone of the display. In some implementations, a combination of an isotropic diffusion layer 900 and an anisotropic diffusion layer 900 may be provided for increased flexibility and control in tailoring the in-plane viewing angle and the viewing cone of the display.

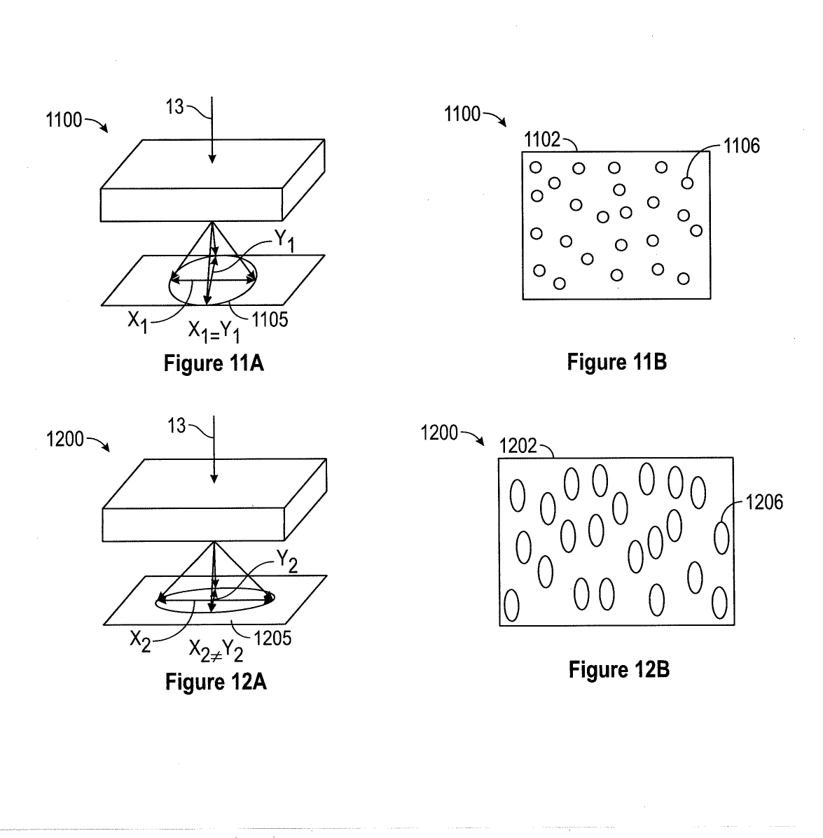

FIG. 11A illustrates an example of an isotropic diffusion layer 1100 according to some implementations. As shown in FIG. 11A, the isotropic diffusion layer 1100 is configured to scatter incident light 13 at an equal scattering angle in both a longitudinal and lateral directions (as indicated by circular scattered light profile 1105). FIG. 11B illustrates a top view of the isotropic diffusion layer 1100 shown in FIG. 11A. The isotropic diffusion layer 1100 includes a binder 1102 and isotropic particles 1106. As shown in FIG. 11B, the isotropic particles 1106 have a circular profile such that, as shown in FIG. 11A, light is scattered by the isotropic particles 1106 at an equal or substantially equal scattering angles in both the longitudinal and lateral directions.

FIG. 12A illustrates an example of an anisotropic diffusion layer 1200 according to some implementations. As shown in FIG. 12A, the anisotropic diffusion layer 1200 is configured to scatter incident light 13 in the longitudinal direction at a different angle than light scattered in the lateral direction (as indicated by elliptical scattered light profile 1205). FIG. 12B illustrates a top view of the anisotropic diffusion layer 1200 shown in FIG. 12A. The anisotropic diffusion layer includes a binder 1202 and anisotropic particles 1206. As shown in FIG. 12B, the anisotropic particles 1206 have an elliptical profile such that, as shown in FIG. 12A, light is scattered by the anisotropic particles 1206 at different scattering angles in the longitudinal and lateral directions.

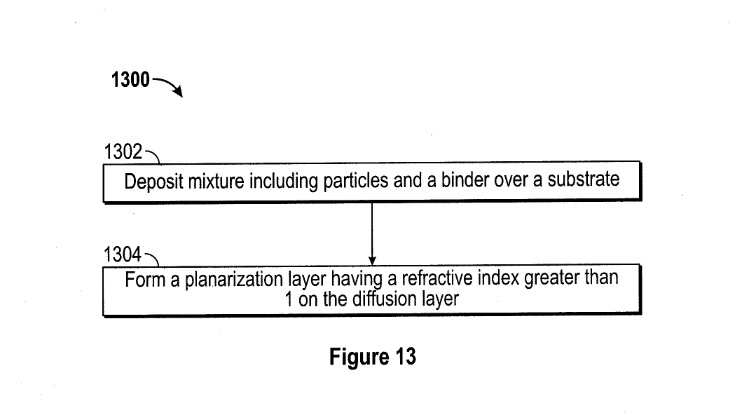

FIG. 13 is a flow diagram illustrating an example manufacturing process for a display including a diffusion layer 900. The diffusion layer 900 is usable with a display including a plurality of display elements. The method 1300 includes depositing a mixture including particles and a binder over a substrate, as shown in block 1302. After depositing the mixture, at least some of the particles protrude from a planar or substantially planar upper surface of the binder in a diffusion layer. For example, a binder 902 may be mixed with particles 906 and the mixture may be spin cast on a surface of a substrate 20. As shown in block 1304, the method further includes forming a planarization layer having a refractive index greater than 1 on the diffusion layer. For example, as discussed herein, a planarization layer 904 can include spin on glass, an epoxy, a light curable transparent resin, a thermo-processed resin, or the like. Air would not be considered a planarization layer 904. The planarization layer 904 may have a refractive index of about 1.01 to about 1.85, and in some implementations from about 1.2 to about 1.8. For example, the planarization layer 904 may have a refractive index of about 1.65. The planarization layer 904 may be formed directly on the diffusion layer 900 such that a surface of the planarization layer 904 is planar or substantially planar so as to enable formation of a display element on a surface of the planarization layer 904. In some implementations, the method 1300 includes foaming a plurality of display elements over the planarization layer.

In some implementations, the topographical pattern of the diffusion layer 900 is common to all IMODs within the IMOD display device. As discussed herein, different IMODs may have a different configuration (for example, different gap heights D₁, D₂, and D₃) in the display. According to some implementations, since the diffusion layer 900 may be formed together with the process of forming the IMODs, the diffusion layer 900 may be configured based on the structure of the corresponding IMOD. For example, the topographical pattern of the diffusion layer 900 may be different for different color IMODs of the display. By adjusting one or more of the parameters discussed herein (e.g., binder 902 to particle 906 ratio), a diffusion layer 900 may, for example, have a topography with variations in pattern and in particular, a topography that has a first pattern for red IMODs, a second pattern for green IMODs, and a third pattern for blue IMODs.

Other than variations in pattern, variations in one or more other parameters such as refractive indices of the layers, particle size, particle shape, layer thicknesses, and binder 902 to particle 906 ratio may be provided to vary the effect of the light diffuser. One or more of these parameters may also be varied in different areas of the display in order to adjust the performance of the display based on the structure of the display elements (such as IMODs). In some implementations, the display includes a plurality of display elements such as the IMODs 12A-12C. The plurality of display elements includes a first set of display elements having a first display area and a second set of display elements having a second display area. The topographical pattern includes a first portion that corresponds to the first display area and a second portion that corresponds to the second display area. The first portion includes a parameter different than the parameter in the second portion. In some implementations, the parameter includes at least one of refractive index of the binder, refractive index of the particles, and volumetric ratio of the binder to the particles. In some implementations, the plurality of display elements further includes a third set of display elements having a third display area. The topographical pattern includes a third portion that corresponds to the third display area, and the third portion includes a parameter different than the parameter in first portion and the parameter in the second portion.

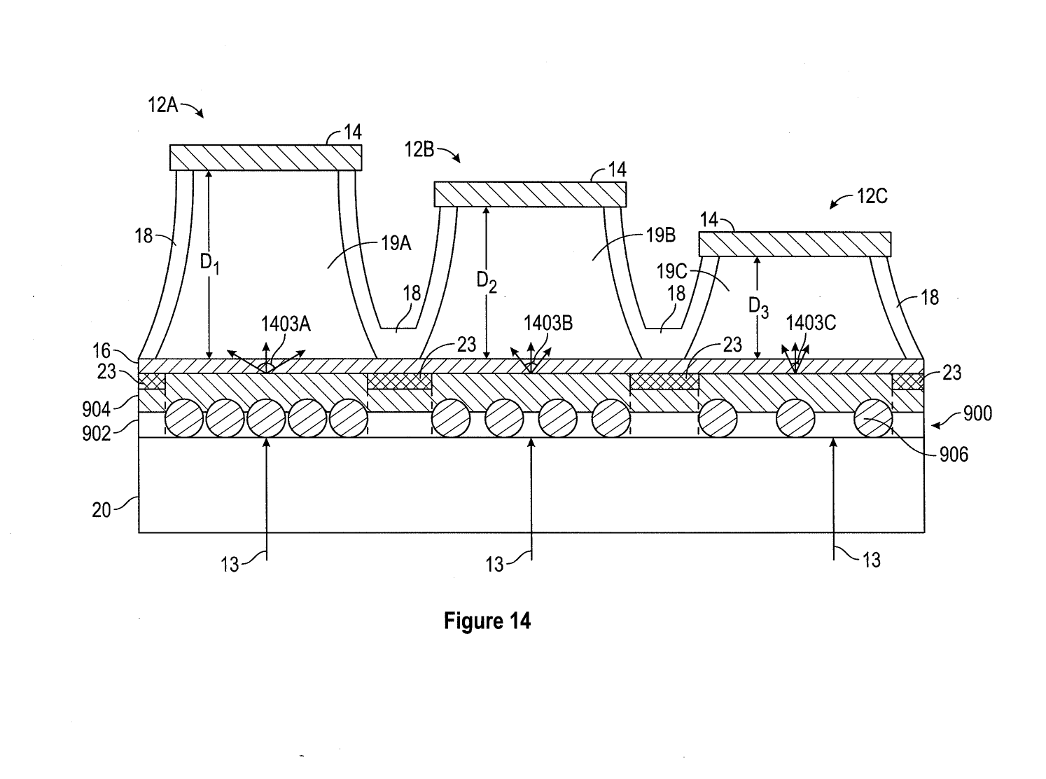

FIG. 14 is a cross-sectional view of a display configured to display different colors and including a diffusion layer 900 having different topographical patterns in different areas of the display. As shown in FIG. 14, the pattern of the particles 906 protruding from the surface of the diffusion layer 900 may be different for different color display elements of the display. The different patterns may be configured to provide for varying degrees of scattering based on the corresponding color IMOD. For example, since light reflecting from the IMOD 12A exhibits a higher rate of change of color with angle of view compared to light which is reflected from the IMODs 12B and 12C, greater scattering of light is provided by the diffusion layer 900 in an area corresponding to the IMOD 12A. The topographical pattern of the diffusion layer 900 in the area corresponding to the IMOD 12A may provide for greater diffusion or scattering than the topographical pattern of the diffusion layer 900 in the areas corresponding to the IMODs 12B and 12C. The topographical pattern of the diffusion layer 900 in the area corresponding to the IMOD 12B may provide for greater diffusion or scattering than the topographical pattern of the diffusion layer 900 in the area corresponding to the IMOD 12C, but may provide for less diffusion or scattering than the topographical pattern of the diffusion layer 900 in the area corresponding to the IMOD 12A. The topographical pattern of the diffusion layer 900 in the area corresponding to the IMOD 12C may provide for less diffusion or scattering than the topographical pattern of the diffusion layer 900 in the areas corresponding to the IMODs 12A and 12B. As a result, the viewing angle and the color gamut of the display may be increased.

As discussed herein, for example with reference to FIGS. 10 and 14, parameters of the diffusion layer 900 may be varied based on the structure of each of the IMOD display elements. For example, a topographical pattern may be configured to provide greater scattering in an area corresponding to an active region of a display element as compared to inactive areas. The active area of the display element may correspond to an area that reflects different colors depending on whether the IMOD is in an actuated state or unactuated state so as to contribute to the formation of an image. For example, the patterns may be configured to improve the effect of black mask structures 23 that are configured to reduce the reflection from inactive regions of the display which disadvantageously reflect light regardless of whether the IMOD is in a dark state or a bright state. As illustrated in FIGS. 10 and 14, the diffusion layer 900 may be configured such that a surface having a reduced light intensity distribution characteristic, such as a planar or substantially planar surface, is provided in the areas corresponding to the black mask structures 23. Although the black mask structures 23 are configured to absorb incident light, a small amount of light that is incident on the black mask structures 23 may be reflected. Since scattering of light from the diffusion layer 900 does not occur in the areas corresponding to the black mask structures 23, light that is reflected by the black mask structures 23 is less likely to be scattered, and the function of the black mask structures 23 may be improved.

Incident light 13 that is incident on the diffusion layer 900 through the substrate 20 is scattered to a plurality of light output angles according to the topography of the diffusion layer 900 and a difference between the refractive index of the diffusion layer 900 and the planarization layer 904. For example, as shown in FIG. 14, in a first area of the diffusion layer 900 corresponding to the IMOD 12A, incident light 13 is scattered to a plurality of light output angles within a range 1403A. In a second area of the diffusion layer 900 corresponding to the IMOD 12B, incident light 13 is scattered to a plurality of light output angles within a range 1403B different than the range 1403A. In a third area of the diffusion layer 900 corresponding to the IMOD 12C, incident light 13 is scattered to a plurality of light output angles within a range 1403C different than the ranges 1403A and 1403B. In some implementations, 1403A>1403B>1403C. The scattering ranges 1403A, 1403B, and 1403C (or angular distribution of light exiting the planarization layer 904) may be a function of one or more parameters (such as refractive indices, particle size, particle shape, layer thicknesses, binder 902 to particle 906 ratio, combinations thereof, and the like) of the diffusion layer 900, the planarization layer 904, and the substrate 20 in the first, second, and third areas, respectively, as discussed herein. Upon reflection by the IMODs 12A, 12B, and 12C, the reflected light may be further scattered by the diffusion layer 900, thereby scattering light reflected from the display elements into a larger range of angles for 1403A than for 1403B and for 1403C. As a result, the performance of the display (e.g., reduction in color shift) may be improved. As illustrated in FIG. 14, in a fourth area of the diffuser 900, corresponding to the black mask structures 23, a planar or substantially planar region of the diffuser 900 may be provided in order to improve the effect of the black mask structures 23. In some implementations, the diffusion layer 900 is configured to scatter light from the display to a plurality of output angles within a first range of angles in a first area of the display and to a plurality of output angles within a second range of angles that is different than the first range of angles in a second area of the display. For example, the first area of the display can correspond to the active area of IMOD 12A as shown in FIG. 14, while the second area of the display can correspond to the active area of IMOD 12B or 12C as shown in FIG. 14.

The patterns of the diffusion layer 900 may also be configured to provide for different beam shapes and/or arrangements. For example, the patterns of different portions of the diffusion layer 900 may provide isotropic scattering of the beam and/or anisotropic scattering of the beam based on the properties of the corresponding IMOD. A plurality of diffusion layers 900 and planarization layers 904 may be stacked such that scattering of both incident and reflected light is a function of the combined effects of the plurality of diffusion layers 900 and planarization layers 904. For example, a display may include a first diffusion layer 900 and a first planarization layer 904 configured to scatter a beam in a first plurality of direction and a second diffusion layer 900 and a second planarization layer 904 configured to scatter the beam in a second plurality of directions different than the first plurality of directions. The second plurality of directions may be a subset of the first plurality of directions. The second plurality of directions may be orthogonal or substantially orthogonal to the first plurality of directions. In some implementations, a single planarization layer 904 may be used and a diffusion layer 900 may be stacked directly on a surface of another diffusion layer 900 (e.g., the binder 902 and particles 906 of the second diffusion layer 900 are formed directly on the binder 902 and particles 906 of the first diffusion layer 900 without a planarization layer 904 between the first diffusion layer 900 and the second diffusion layer 900). The planarization layer 904 may be provided on a diffusion layer 900 that is proximate to the surface of the IMODs 12. The planarization layer 904 provides a planar or substantially planar surface for formation of the IMODs 12 on the light diffuser (e.g., diffusion layer 900 and planarization layer 904).

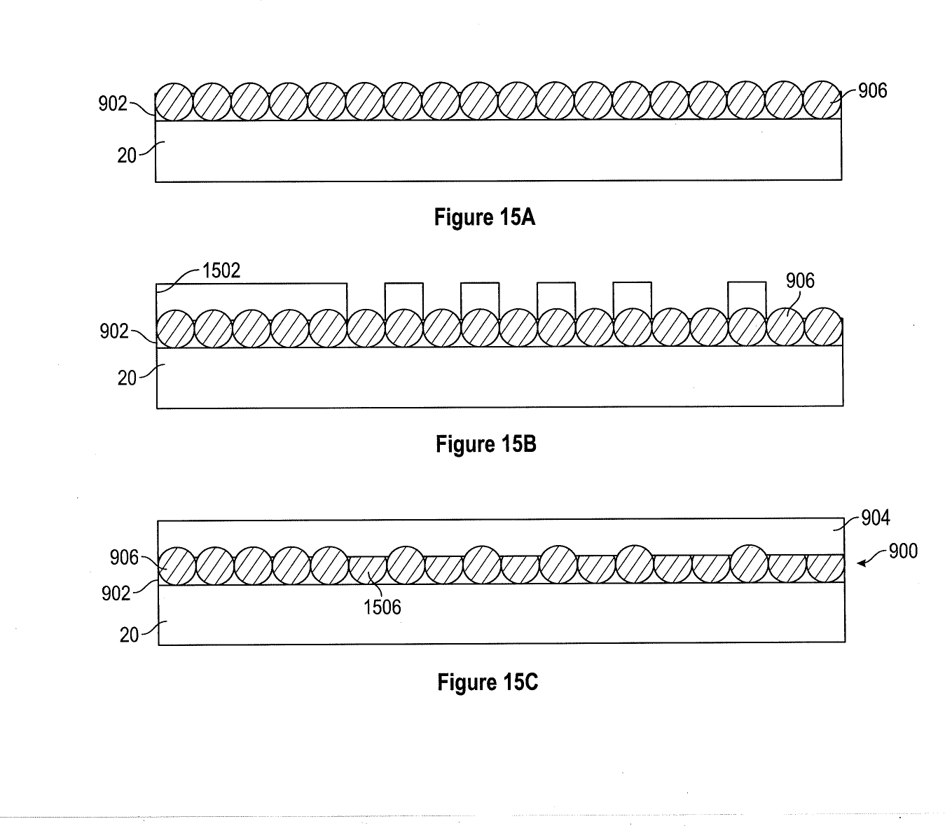

FIGS. 15A-15C illustrate cross sections of light diffusers during fabrication of a diffusion layer 900 having different topographical patterns in different areas. As shown in FIG. 15A, a mixture including particles 906 and a binder 902 can be deposited on the surface of a substrate 20. A mask layer 1502 can be formed on the surface of the deposited mixture, as shown in FIG. 15B, for example using standard photoresist processing. As illustrated, the mask layer 1502 includes different patterns in different areas along a surface of the substrate 20. An etching process may be performed on the masked structure in order to remove portions of the particles 906. For example, as shown in FIG. 15C, following the etching process, the diffusion layer 900 can include particles 906 which are maintained as spherical particles in some areas, as well as hemispherical particles 906 having a surface that is planar or substantially planar with a surface of the binder 902 in other areas. After removal of the mask layer 1502, a planarization layer 904 may then be deposited on the diffusion layer 900. As shown in FIG. 15C, the diffusion layer 900 includes different topographical patterns in different areas of the diffusion layer 900. The different patterns may correspond to different display elements such as IMODs that are formed on the surface of the planarization layer 904, inactive or black mask areas, and the like, for example as discussed herein.

This process may be modified to produce variations in parameters other than patterns, such as refractive indices of the layers, particle size, particle shape, layer thicknesses, and binder 902 to particle 906 ratio to vary the effect of the light diffuser. The process may be modified such that each of these parameters may also be varied in different areas of the display in order to adjust the performance of the display based on the structure of the display elements (such as IMODs).The implementations described above may improve the contrast ratio of an IMOD display based on a viewing angle, and reduce the effect of color change due to color shift. The contrast ratio, which corresponds to a ratio of reflected light intensity at a particular wavelength from a reflective area (such as an active region of an un-actuated display element) to reflected light intensity from a substantially non-reflective region (such as a black-mask region of a display element, or an actuated display element), may be reduced for viewing angles that deviate from a specular viewing angle (e.g. angle corresponding to specular reflection of incident light). The change in contrast ratio may be caused by the lower intensity of reflected light at viewing angles that deviate from the viewing angle corresponding to specular reflection. For example, a contrast ratio of approximately 10 at a specular viewing angle may be about 2 at angles of +/−15 degrees from the specular viewing angle. According to some implementations, the diffuser acts on light reflected by substantially reflective display regions (such as active regions of an un-actuated display element) and not on light reflected by substantially non-reflective display regions (such as inactive areas of a display element). Therefore, the ratio of the combined reflectivity Y_RGB attributed to color and the reflectivity Y_black attributed to inactive regions may be improved. According to the implementations described above, for a display exhibiting a full width half maximum (FWHM) of approximately 30 degrees, and a contrast ratio at a specular viewing angle of about 9.9, the contrast ratio remains greater than about 5 within a range of about +/−30 degrees from the specular viewing angle.

Using color specific diffusers having less diffusion for some display elements than other display elements reduces color shift while maintaining brightness for light reflected by different display elements. For example, as discussed above, a diffuser may be provided that has a greater scattering effect for blue IMODs than for red and green IMODs in order to offset the effect of greater color shift exhibited by blue light reflected from the blue IMODs. The reduced scattering effect for red and green IMODs also maintains brightness levels since the diffuser does not overly de-saturate light reflected from the red and green IMODs. In some implementations, the color specific diffusers may also be configured to selectively smooth the color dependence for an individual wavelength, or pronounce particular wavelengths.

Light rays that are incident on and reflected by the display (such as an IMOD display) which includes the diffuser is scattered on an incidence path to a reflective portion of a display element, and on a return path following reflection by the display element. As a result, the scattering characteristics of light, such as a scattering angle, may be greater than conventional non-reflective displays which utilize diffusers.

A wide variety of variations for forming the layers is possible. Although the terms “film” and “layer” have been used herein, such terms as used herein may include film stacks and multilayers. Such film stacks and multilayers may be adhered to other structures using adhesive or may be formed on other structures using deposition techniques or in other manners. Several geometric arrangements of the multiple optical layers can be produced on the substrate 20 using known manufacturing techniques to provide a thin display device having certain desired optical characteristics. The diffusion layer may be integrated in interferometric displays or other types of reflective displays, including but not limited to displays including display elements based on electromechanical systems such as MEMS and NEMS, as well as other types of reflective displays.

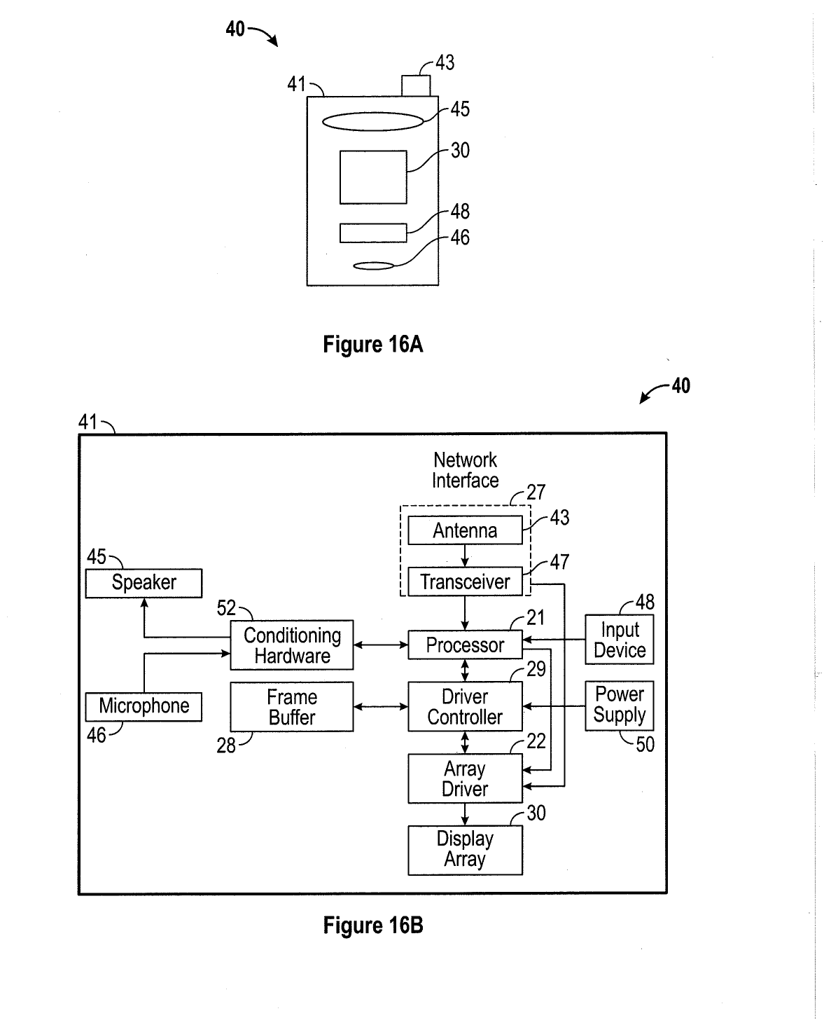

FIGS. 16A and 16B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum foaming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 16B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A light diffuser comprising:
a substrate;
a diffusion layer over the substrate, the diffusion layer including particles and a binder, at least some of the particles protruding from a planar upper surface of the binder; and
a planarization layer on the diffusion layer, wherein the planarization layer has a refractive index greater than 1.

2. The diffuser of claim 1, wherein the diffusion layer is configured to scatter incident light to a plurality of light output angles.

3. The diffuser of claim 1, wherein the binder includes one of a spin on glass, an epoxy, a light curable transparent resin, or a thermo-processed transparent resin.

4. The diffuser of claim 1, wherein a refractive index of the particles is less than or greater than a refractive index of the binder.

5. The diffuser of claim 1, wherein portions of the particles protruding above the planar upper surface of the binder are substantially hemispherical.

6. The diffuser of claim 1, wherein the planarization layer includes one of a spin on glass, an epoxy, a light curable transparent resin, or a thermo-processed transparent resin.

7. The diffuser of claim 1, wherein a refractive index of the binder is substantially equal to the refractive index of the planarization layer.

8. The diffuser of claim 1, wherein the refractive index of the particles is less than or greater than a refractive index of the planarization layer.

9. The diffuser of claim 1, wherein the refractive index of the binder is less than or greater than the refractive index of the planarization layer.

10. A display comprising:
the diffuser of claim 1; and
a plurality of display elements over the planarization layer, wherein the diffuser includes a topographical pattern of the particles, and wherein the topographical pattern varies according to at least one of different display elements of the plurality of display elements and different components of a display element of the plurality of display elements.

11. The display of claim 10, wherein the diffusion layer is configured to scatter incident light to a plurality of light output angles.

12. The display of claim 10, wherein the plurality of display elements includes a first set of display elements having a first display area and a second set of display elements having a second display area, wherein the topographical pattern includes a first portion that corresponds to the first display area and a second portion that corresponds to the second display area, and wherein the first portion includes a parameter different than the parameter in the second portion.

13. The display of claim 12, wherein the parameter includes at least one of refractive index of the binder, refractive index of the particles, and volumetric ratio of the binder to the particles.

14. The display of claim 10, wherein the plurality of display elements further includes a third set of display elements having a third display area, and wherein the topographical pattern includes a third portion that corresponds to the third display area, and wherein the third portion includes a parameter different than the parameter in first portion and the parameter in the second portion.

15. The display of claim 10, further comprising:
a processor configured to communicate with the light-modulating array and configured to process image data; and
a memory device configured to communicate with the processor.

16. The display of claim 15, further comprising a driver circuit configured to send at least one signal to the light-modulating array.

17. The display of claim 16, further comprising a controller configured to send at least a portion of the image data to the driver circuit.

18. The display of claim 15, further comprising an image source module configured to send the image data to the processor.

19. The display of claim 18, wherein the image source module includes at least one of a receiver, a transceiver, and a transmitter.

20. The display of claim 15, further comprising an input device configured to receive input data and to communicate the input data to the processor.

21. A method of manufacturing a diffuser usable with a display including a plurality of display elements, the method comprising:
depositing a mixture including particles and a binder over a substrate, wherein, after depositing the mixture, at least some of the particles protrude from a planar upper surface of the binder in a diffusion layer; and
forming a planarization layer having a refractive index greater than 1 on the diffusion layer.

22. The method of claim 21, wherein the diffusion layer includes a topographical pattern that varies according to different display elements of the plurality of display elements or according to different components of a display element of the plurality of display elements, wherein the diffusion layer is configured to scatter incident light to a plurality of light output angles.

23. The method of claim 22, further comprising forming the plurality of display elements over the planarization layer.

24. A diffuser comprising:
a substrate;
means for scattering light, the scattering means over the substrate and including particles and a binder, at least some of the particles protruding from a planar upper surface of the binder; and
a planarization layer on the diffusion layer, the planarization layer having a refractive index greater than 1.

25. The diffuser of claim 24, wherein the scattering means includes a diffusion layer.

26. A display comprising:
the diffuser of claim 24; and
a plurality of display elements over the planarization layer, wherein the scattering means includes a topographical pattern of the particles, and wherein the topographical pattern varies according to at least one of different display elements of the plurality of display elements and different components of a display element of the plurality of display elements.

27. The display of claim 26, wherein the plurality of display elements includes a first set of display elements having a first display area and a second set of display elements having a second display area, wherein the topographical pattern includes a first portion that corresponds to the first display area and a second portion that corresponds to the second display area, and wherein the first portion includes a parameter different than the parameter in the second portion.
